(19) United States
(12) Patent Application Publication
(10) Pub. No.: US 2013/0160127 A1
(43) Pub. Date: Jun. 20, 2013

(54) SYSTEM AND METHOD FOR DETECTING MALICIOUS CODE OF PDF DOCUMENT TYPE

(71) Applicants: Hyun Cheol Jeong, Seoul (KR); Seung Goo Ji, Seoul (KR); Tai Jin Lee, Seoul (KR); Jong Il Jeong, Seoul (KR); Hong Koo Kang, Seoul (KR); Byung Ik Kim, Seoul (KR)

(72) Inventors: Hyun Cheol Jeong, Seoul (KR); Seung Goo Ji, Seoul (KR); Tai Jin Lee, Seoul (KR); Jong Il Jeong, Seoul (KR); Hong Koo Kang, Seoul (KR); Byung Ik Kim, Seoul (KR)

(73) Assignee: Korea Internet & Security Agency, Seoul (KR)

(21) Appl. No.: 13/657,303

(22) Filed: Oct. 22, 2012

(30) Foreign Application Priority Data
Dec. 14, 2011 (KR) 10-2011-0134208

(51) Int. Cl. G06F 21/00

(52) U.S. Cl. 726/24

(57) ABSTRACT

Disclosed herein is a PDF document type malicious code detection system for efficiently detecting a malicious code embedded in a document type and a method thereof. The present invention may perform a dynamic and static analysis on JavaScript within a PDF document, and execute the PDF document to perform a PDF dynamic analysis, thereby achieving an effect of efficiently extracting a malicious code embedded in the PDF document.

### RELATED APPLICATION

Pursuant to 35 U.S.C. §119(a), this application claims the benefit of Korean Application No 10-2011-0134208, filed on Dec. 14, 2011, the contents of which is hereby incorporated by reference herein in its entirety.

### BACKGROUND OF THE INVENTION

1. Field of the Invention

The present invention relates to a PDF document type malicious code detection system and a method thereof, and more particularly, to a PDF document type malicious code detection system for efficiently detecting a malicious code embedded in a document type and a method thereof.

2. Description of the Related Art

Computer viruses have been developed in various forms such as viruses aiming at file infection, worms attempting rapid proliferation through a network, and Trojan horses for data leakage.

The advent of such malicious codes has increased every year, and particularly new types of malicious code propagation have been generated thus causing more anxiety to computer users.

For a code type that has been propagated in recent years, there may be malicious code propagation through a Portable Document Format (PDF) document. Such propagation has been caused by vulnerability existing in only PDF documents.

For example, malicious code propagation has been easily carried out due to the vulnerability in which TTF fonts cannot be properly parsed in the cooltype.dll 0x0803dcf9 module, the vulnerability in which JavaScript called “AcroJS” is enabled to be automatically implemented, and the like.

As a result, in order to cope with malicious code propagation through PDF documents that have recently increased, it may be required to present a new scheme capable of analyzing a type of malicious code within a PDF document and automatically and easily detecting it.

### SUMMARY OF THE INVENTION

The present invention is contrived to solve the foregoing problems, and the objective of the present invention is to provide a PDF document type malicious code detection system capable of dynamically and/or statically analyzing JavaScript within the object information and malicious code patterns therein to find out a malicious code embedded in a PDF document and efficiently detecting a malicious code, and a method thereof.

The features of the present invention for accomplishing the foregoing objective, of the present invention and implementing a peculiar function of the present invention that follows will be described below.

According to an aspect of the present invention, there is provided a PDF document type malicious code detection system, including an object extraction module configured to find and extract a plurality of object information contained within a collected PDF document; a script merge module configured to merge each first JavaScript information from the plurality of extracted object information to generate second JavaScript information; an obfuscation release module configured to decrypt/decode the obfuscated/encoded second JavaScript information to generate third JavaScript information when the generated second JavaScript information is obfuscated/encoded; a script static module configured to parse the generated third JavaScript information to extract function/pattern information suspected as a malicious code; a script dynamic module to execute fourth JavaScript information containing the function and pattern information to generate behavior information according to a malicious behavior; and a malicious code extraction module configured to extract malicious code information from the behavior information when it is confirmed that a malicious code has been generated.

Here, a PDF document type malicious code detection system according to the present invention may further include a PDF dynamic module, and the PDF dynamic module may execute the stored PDF document to perform a behavior analysis when there is no first JavaScript information within the plurality of extracted object information.

Furthermore, the malicious code extraction module may extract malicious code information confirmed through the behavior analysis.

Furthermore, the object extraction module may extract a plurality of object information containing at least one of each text information, first JavaScript information and table information.

Furthermore, the script static module may extract function/pattern information containing at least one of a URL, a PE file (execution file), a JS.HTM file, a code command such as Run or Shea, and a code command such as Copy or Create.

Furthermore, according to another aspect of the present invention, there is provided a document type malicious code detection method, and the method may include the steps of (a) parsing a plurality of object information contained within a collected PDF document; (b) determining whether there is first JavaScript information within the plurality of object information as a result of the analysis; (c) merging the first JavaScript information when it is determined that there is the first to JavaScript information as a result of the determination; (d) determining whether second JavaScript information generated by the merging is obfuscated/encoded: (e) decrypting/decoding the second JavaScript information when it is obfuscated/encoded as a result of the determination; (f) parsing the decrypted/decoded and generated third JavaScript information to perform a script static analysis; (g) performing a script dynamic analysis on fourth JavaScript generated to contain function/pattern information suspected as a malicious code by the script static analysis; and (h) extracting malicious code information from behavior information acquired by the script dynamic analysis.

Here, the method may further include (i) executing the collected PDF document to perform a dynamic behavior analysis when it is determined that there is no first JavaScript information as a result of the determination in the step (b).

Furthermore, the step (h) may further include (h-1) extracting malicious code information from behavior information acquired through the dynamic behavior analysis in the step (i).

Furthermore, the step (f) may parse the second JavaScript information to perform a script static analysis when it is not obfuscated/encoded as a result of the determination in the step (d),

Furthermore, the script static analysis by the second JavaScript information may be performed, and then the steps (g) and (h) may be performed for the result.

As described above, according to the present invention, JavaScript may be extracted and merged from a plurality of object information contained within a PDF document, and parsed to implement a static analysis, and implement a dynamic analysis on JavaScript containing function/pattern information generated by the analysis, thereby achieving an effect of efficiently extracting a malicious code embedded in the PDF document.

Furthermore, according to the present invention, even though JavaScript within a PDF document merged as described above is obfuscated/encoded, it may be released to implement a script static analysis and dynamic analysis, thereby achieving an effect of efficiently extracting even a malicious code due to obfuscation/encoding within the PDF document.

Furthermore, according to the present invention, even though there is no JavaScript within a PDF document, it may have an effect of efficiently extracting a malicious code embedded in the PDF document through a dynamic behavior analysis.

### BRIEF DESCRIPTION OF THE DRAWINGS

The accompanying drawings, which are included to provide a further understanding of the invention and are incorporated in and constitute a part of this specification illustrate embodiments of the invention and together with the description serve to explain the principles of the invention.

In the drawings:

FIG. 1 is an exemplary view illustrating a PDF document type malicious code detection system 100 according to a first embodiment of the present invention;

FIG. 2 is an exemplary view illustrating a PDF document type malicious code detection method (S100) according to a second embodiment of the present invention; and

FIG. 3 is a view diagrammatically illustrating key processes (S160-S180) of the PDF document type malicious code detection method (S100) according to a second embodiment of the present invention.

### DETAILED DESCRIPTION OF THE INVENTION

Hereinafter, preferred embodiments of the present invention will be described in detail with reference to the accompanying drawings to such an extent that the present invention can be easily implemented by a person having ordinary skill in the art to which the present invention pertains. The same or similar reference numerals in the drawings designate the same or similar functions throughout various aspects thereof.

### First Embodiment

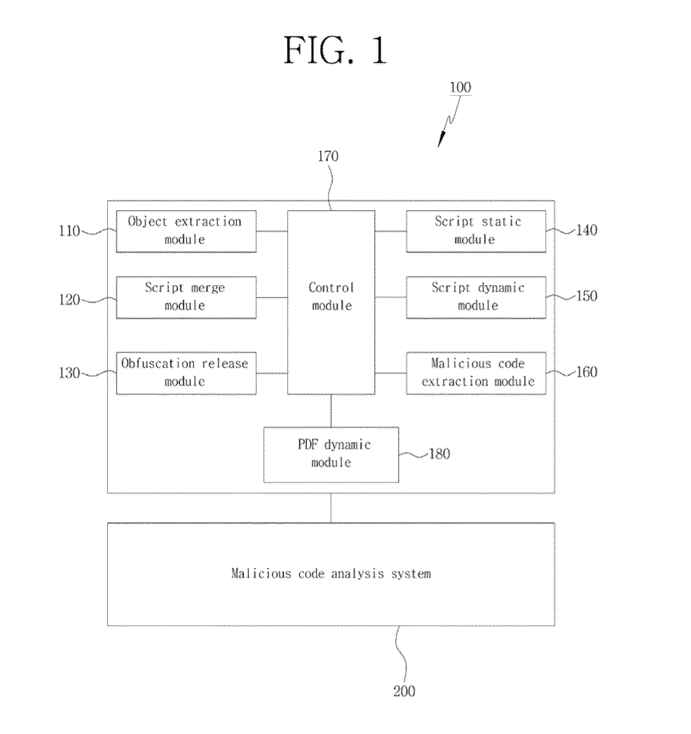

FIG. 1 is an exemplary view illustrating a PDF document type malicious code detection system 100 according to a first embodiment of the present invention.

As illustrated in FIG. 1, the PDF document type malicious code detection system 100 according to a first embodiment of the present invention is a device for extracting a malicious code embedded in a PDF document, and may include an object extraction module 110, a script merge nodule 120, an obfuscation release module 130, a script static module 140, a script dynamic module 150, a malicious code extraction module 160, and a control module 170.

First, the object extraction module 110 collects a PDF document likely to be infected with a malicious code, and then performs a function of extracting a plurality of object information contained within the PDF document through the syntactic (structural) analysis of the PDF document. The syntactic analysis of a PDF document is typically carried out by a publicly known tool.

Here, the plurality of extracted object information contain at least one of information such as first JavaScript information and table information corresponding to source codes as well as text information written on the PDF document, respectively.

Next, the script merge module 120 first performs a function of merging first JavaScript information confirmed in the plurality of object information extracted, by the object extraction module 110. The first JavaScript information has a complicated connecting structure or format such as being entangled or scattered with a link relation for each object information, and thus it is not easy to find all first JavaScript information.

Regarding this, the script merge module 120 collectively determines a syntactic structure and a first JavaScript structure within object information to merge all first JavaScript existing within a plurality of object information. At this 25time, a result merged by the script merge module 120 is referred to as “second JavaScript information” to discriminate it from the first JavaScript contained in object information.

Next, the obfuscation release module 130 checks whether second JavaScript information generated by the script merge module 120 is obfuscated/encoded, and then performs a function of decrypting/decoding the obfuscated/encoded second JavaScript information.

At this time, the second JavaScript information being configured with an obfuscated/encoded form denotes that a malicious code is embedded therein to disable its interpretation (analysis), and therefore, decryption/decoding is carried out to decipher it.

However, since malicious codes may exist therein even though it is not obfuscated/encoded within second JavaScript information, in this case, the second JavaScript information acquired by the script merge module 120 is transferred to the script static module 140 which will be described later. On the other hand, information decrypted/decoded and generated by the obfuscation release module 130 is referred to as “third JavaScript information”.

Next, the script static module 140 is a module for performing a static analysis on third JavaScript information generated by the obfuscation release module 130, and the script static module 140 performs a function of parsing the third JavaScript information and extracting function/pattern information suspected as a malicious code.

When the third JavaScript information is parsed, function/pattern information containing at least one of a URL, a PE file (execution file), a JS.HTM file, a code command such as Run or Shell, and a code command such as Copy or Create is exhibited like a viewer. At this time, JavaScript containing the function/pattern information is referred to as “fourth JavaScript information”. As a result, the script static module 140 performs a function of generating fourth JavaScript information containing function/pattern information.

Next, the script dynamic module 150 executes fourth JavaScript containing function and pattern information generated by the script static module 140 to perform a dynamic analysis. When a dynamic analysis is carried out by executing the acquired fourth JavaScript, it may be possible to obtain behaviors suspected as a malicious code.

For example, it may be possible to obtain behavior information such as a generation file status, a registry approach status, a change, a system setting change status, a network access status, a service approach status, a system approach status, a DLL load status, and the like. The behavior information is obtained through the execution of the fourth JavaScript acquired as described above, and thus the script dynamic module 150 according to the present invention can check whether or not a malicious code is generated.

Next, the malicious code extraction module 160 performs a function of extracting (detecting) malicious code information confirmed by the dynamic analysis of the script dynamic module 150. The malicious code information detected as described above is transferred to the malicious code analysis system 200 to perform an automatic analysis, thereby precisely analyzing a malicious code embedded in, a PDF document.

Finally, the control module 170 controls data flows between the object extraction module 110, script merge module 120, obfuscation release module 130, script static module 140, script dynamic module 150, malicious code extraction module 160, and PDF dynamic module 180, and as a result, the object extraction module 110, script merge module 120, obfuscation release module 130, script static module 140, script dynamic module 150, and malicious code extraction module 160 perform their own data processing respectively.

As described above, according to the present first embodiment, JavaScript contained in a PDF document may be parsed by releasing the obfuscation/encoding thereof to perform a dynamic and static analysis on this, thereby automatically detecting a malicious code embedded within the PDF document.

On the other hand, the PDF document type malicious code detection system 100 according to according to a first embodiment of the present invention may further include the PDF dynamic module 180. The PDF dynamic module 180 is implemented only for a case that there is no first JavaScript information within a plurality of object information extracted by the object extraction module 110. It is because there may exist a malicious code within a PDF document even though there is no first JavaScript information.

Accordingly, when there is no first JavaScript information within a plurality of object information extracted by the object extraction module 110, the PDF dynamic module 180 performs a function of executing a PDF document stored therein to perform a behavior analysis.

The PDF dynamic module 180 may obtain behavior information through a dynamic analysis (behavior analysis) similarly to the script dynamic module 150 as described in the above. However, there is only a difference in that the script dynamic module 150 executes the acquired fourth JavaScript information to obtain behavior information whereas the PDF dynamic module 180 directly executes the PDF document without acquiring JavaScript subject to malicious code detection to obtain behavior information.

When a behavior analysis is completed by the PDF dynamic module 180, malicious code information confirmed by behavior analysis is transferred to the foregoing malicious code extraction module 160. Accordingly, the malicious code extraction module 160 extracts malicious code information confirmed through the behavior analysis of the PDF dynamic module 180. The extracted malicious code information is transferred to the malicious code analysis system 200 to perform an automatic analysis. On the other hand, it is preferable that the PDF dynamic module 180 performs a dynamic analysis (behavior analysis) under an emulator or virtual machine environment. Meanwhile, the PDF dynamic module 180 is of course controlled by the control module 170.

When the PDF dynamic module 180 is further provided therein, it may be possible to easily detect a malicious code through a dynamic analysis on the PDF document without using JavaScript even though the malicious code exists in the PDF document.

### Second Embodiment

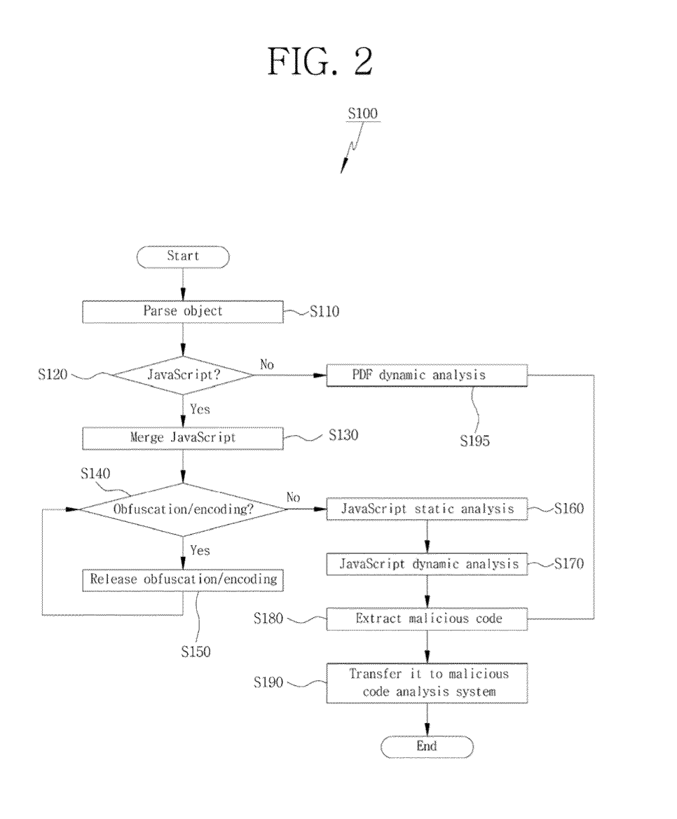

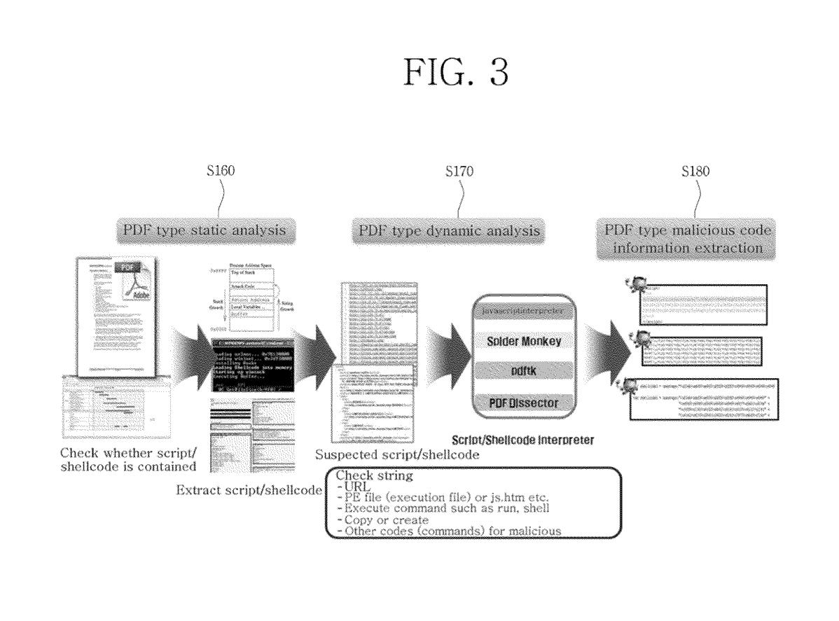

FIG. 2 is an exemplary view illustrating a PDF document type malicious code detection method (S100) according to a second embodiment of the present invention, and FIG. 3 is a view diagrammatically illustrating key processes (S180-S180) of the PDF document type malicious code detection method (S100) according to a second embodiment of the present invention.

As described above, a PDF document type malicious code detection method (S100) according to a second embodiment of the present invention is a method for detecting a malicious code contained in a PDF document, which includes the steps S110 through S190. Here, the meaning of each information which will be described below has been sufficiently described in the above, as illustrated in FIG. 1, and thus the description thereof will be omitted.

First, in the step S110, a syntactic analysis is implemented for a plurality of object information contained within a collected PDF document.

Then, in the step S120, it is determined whether there is first JavaScript information within the plurality of object information as a result of the analysis in the step S110. When there is first JavaScript information, the step S130 is implemented, and otherwise, the step S110 is implemented. At this time, the step S110 is implemented because there is a malicious code within a PDF document even though there is no first JavaScript information. The step S110 will be described later.

Then, in the step S130, the first JavaScript information being scattered for each object information is merged when it is determined that there is the first JavaScript information as a result of the determination in the step S120.

Then, in the step S140, it is determined whether second JavaScript information generated by the merging in the step S130 is obfuscated/encoded. Here, being obfuscated/encoded is supposed to be interpreted as a state in which a malicious code is embedded within a PDF document. As a result of the determination, when the second JavaScript information is obfuscated/encoded, the step S150 is implemented, and otherwise, the step S160 is implemented.

Then, in the step S150, the second JavaScript information is decrypted/decoded when the second JavaScript information is obfuscated/encoded as a result of the determination in the step S140 At this time, decrypting/decoding the second JavaScript information is a process of releasing the obfuscation/encoding.

When the second JavaScript information is normally decrypted/decoded, the decrypted/decoded third JavaScript is generated and transferred to the steps S140 and S150 again.

Then, in the step S160, the decrypted/decoded and generated third JavaScript information is parsed to perform a script static analysis when it is determined that the second JavaScript information is not obfuscated/encoded by the step S140. When the third JavaScript information is parsed, it is possible to acquire function/pattern information suspected as a malicious code.

The acquired function/pattern information may include at least one of a URL, a PE file (execution file), a JS.HTM file, a code command such as Run or Shell, and a code command such as Copy or Create. It is seen that it approaches closely to malicious code detection by acquiring the function/pattern information. Accordingly, in the step S160, fourth JavaScript containing function/pattern information suspected as a malicious code is generated and transferred to the step S170.

Moreover, in the step S160 the second JavaScript information generated by the merging of the step S130 is parsed to perform a script static analysis when it is not obfuscated/encoded as a result of the determination in the step S140. At this time, the script static analysis by parsing acquires function/pattern information suspected as a malicious code, and generates a script with a type similar to the fourth JavaScript as described above.

Then, in the step S170, the fourth JavaScript information containing function/pattern information suspected as a malicious code is received from the step S150 through the script static analysis by the step S160 to perform a script dynamic analysis for the fourth JavaScript. Here, when performing the fourth JavaScript, it may be possible to acquire behavior information suspected as a malicious code through the dynamic analysis.

The acquired behavior information may include a generation file status, a registry approach status, a change, a system setting change status, a network access status, a service approach status, a system approach status, a DLL load status, and the like.

Then, in the step S180, it may be possible to acquire malicious code information from behavior information acquired by the script dynamic analysis. The malicious code information extracted as described above is transferred to the malicious code analysis system 200 to perform an automatic analysis (S190).

In this manner, according to the present second embodiment, JavaScript contained in a PDF document may be parsed by releasing the obfuscation/encoding thereof to perform a dynamic and static analysis on this, thereby providing an advantage in automatically detecting a malicious code embedded within the PDF document by JavaScript.

On the other hand, a PDF document type malicious code detection method (S100) according to a second embodiment of the present invention may further include the step S195. In the step S195, a dynamic behavior analysis is implemented by executing a PDF document collected in the step S110 when it is determined that there is no first JavaScript information as a result of the determination in the foregoing step S120.

When the dynamic behavior analysis is carried out, it may be possible to obtain behavior information though a dynamic analysis (behavior analysis) similarly to the step S170. However, there is only a difference in that the step S170 executes the acquired fourth JavaScript information to obtain behavior information whereas the step S195 directly executes the PDF document without acquiring JavaScript subject to malicious code detection to obtain behavior information.

When the step S195 is completed, the step S180 is carried out. In the step S180, it may be possible to extract malicious code information from behavior information acquired by the step S195. Here, the malicious code may be similar to or different from a malicious code previously acquired by the steps S110 through S170. The extracted malicious code information is transferred to the malicious code analysis system 200 to perform an analysis (S190).

When the steps S195, S180, and S190 are further carried out in this manner, it may be possible to easily detect a malicious code by performing a dynamic analysis through the execution of the PDF document without using JavaScript even though the malicious code exists in the PDF document.

As described above, the preferred embodiments of the present invention have been described with reference to the accompanying drawings, but it will be apparent to those having ordinary skill in the art to which the invention pertains that the invention can be embodied in other specific forms without departing from the concept and essential characteristics thereof. It should be understood that the foregoing embodiments are merely illustrative but not restrictive in all aspects.

What is claimed:

1. A PDF document type malicious code detection system, comprising:
an object extraction module configured to find and extract a plurality of object information contained within a collected PDF document;
a script merge module configured to merge each first JavaScript information from the plurality of extracted object information to generate second JavaScript information;
an obfuscation release module configured to decrypt/decode the obfuscated/encoded second JavaScript information to generate third JavaScript information when the generated second JavaScript information is obfuscated/encoded;
a script static module configured to parse the generated third JavaScript information to extract function/pattern information suspected as a malicious code;
a script dynamic module to execute fourth JavaScript information containing the function and pattern information to generate behavior information according to a malicious behavior; and
a malicious code extraction module configured to extract malicious code information from the behavior information when it is confirmed that a malicious code has been generated.

2. The PDF document type malicious code detection system of claim 1, further comprising:
a PDF dynamic module,
wherein the PDF dynamic module executes the stored PDF document to perform a behavior analysis when there is no first JavaScript information within the plurality of extracted object information.

3. The PDF document type malicious code detection system of claim 2, wherein the malicious code extraction module extracts malicious code information confirmed through the behavior analysis.

4. The PDF document type malicious code detection system of claim 3, wherein the object extraction module extracts a plurality of object information containing at least one of each text information, first JavaScript information and table information.

5. The PDF document type malicious code detection system of claim wherein the script static module extracts function/pattern information containing at least one of a URL, a PE file (execution file), a JS.HTM file, a code command such as Run or Shell, and a code command such as Copy or Create.

6. A PDF document type malicious code detection method, the method comprising:
(a) parsing a plurality of object information contained within a collected PDF document;
(b) determining whether there is first JavaScript information within the plurality of object information as a result of the analysis;
(c) merging the first JavaScript information when it is determined that there is the first JavaScript information as a result of the determination;
(d) determining whether second JavaScript information generated by the merging is obfuscated/encoded;
(e) decrypting/decoding the second JavaScript information when it is obfuscated/encoded as a result of the determination;
(f) parsing the decrypted/decoded and generated third JavaScript information to perform a script static analysis;
(g) performing a script dynamic analysis on fourth JavaScript generated to contain function/pattern information suspected as a malicious code by the script static analysis; and
(h) extracting malicious code information from behavior information acquired by the script dynamic analysis.

7. The method of claim 6, further comprising:
(i) executing the collected PDF document to perform a dynamic behavior analysis when it is determined that there is no first JavaScript information as a result of the determination in the step (b).

8. The method of claim 7, wherein the step (h) further comprises:)
(h-1) extracting malicious code information from behavior information acquired through the dynamic behavior analysis in the step D.

9. The method of claim 6, wherein the step (f) parses the second JavaScript information to perform a script static analysis when it is not obfuscated/encoded as a result of the determination in the step (d),

10. The method of claim 9, wherein the script static analysis by the second JavaScript information is performed, and then the steps (g) and (h) are performed for the result.
